(19) United States
(12) Patent Application Publication
(10) Pub. No.: US 2007/0228074 A1
(43) Pub. Date: Oct. 4, 2007

(54) SPRAY BOTTLE NECK FINISH

(76) Inventors: Edward L. Mueller, Toledo, OH (US); Douglas F. Taylor, Toledo, OH (US); R. Bruce Yacko, Toledo, OH (US)

Correspondence Address: FRASER CLEMENS MARTIN & MILLER LLC, 28366 KENSINGTON LANE, PERRYSBURG, OH, 43551, US

(21) Appl. No.: 11/684,814

(22) Filed: Mar. 12, 2007

Related U.S. Application Data
(60) Provisional application No. 60/788,676, filed on Apr. 3, 2006.

(51) Int. Cl. B67D 5/56

(52) U.S. Cl. 222/129; 222/136

(57) ABSTRACT

A container with a neck finish having a recess for receiving a flange of a concentrate cartridge to effect total sealing between the closure cap of a sprayer pump assembly and the associated container.

### CROSS-REFERENCE TO RELATED APPLICATION

This application claims the benefit of U.S. Provisional Patent Application Ser. No. 60/788,676 filed Apr. 3, 2006.

### FIELD OF THE INVENTION

The invention relates to a container for dispensing fluids and more particularly to a neck portion of a container for dispensing a solution of a plurality of constituents where one of the constituents is introduced into the container from a cartridge holding a quantity of a concentrated material.

### BACKGROUND OF THE INVENTION

Presently there are available containers for multi-constituent systems, which are designed to dilute and dispense a concentrated material. The concentrated material is supplied in a separately packaged cartridge that is easily inserted into the neck of a reusable diluting and dispensing container.

One such cartridge is described in U.S. Pat. No. 6,290,100 to Yacko et al. entitled CONCENTRATE CARTRIDGE FOR A DILUTING AND DISPENSING CONTAINER, incorporated herein by reference in its entirety.

The concentrate cartridge disclosed in the '100 patent comprises a hollow cylindrical element having a first open end forming a closure seat and a second end including a flange extending radially outwardly from the cylindrical element, and a hollow tube having a first end portion in substantially fluid tight sliding relation with the second end of the cylindrical element and a second end terminating in a radially outwardly extending closure adapted to selectively seat with the closure seat of the hollow cylindrical element to form a substantially fluid tight seal therebetween.

The radially outwardly extending closure is opened in response to a downward force applied to the first end portion of the hollow tube, wherein the closure element is caused to unseat from the closure seat of the cylindrical element. The hollow cylindrical body of the cartridge is held in place in the dispensing container wherein the lower surface of the radially outwardly extending flange of the cartridge is supported on an upper land portion of the neck of the container.

A closure cap is utilized to apply axial force to urge the hollow tube downwardly until the closure is opened allowing the concentrated material to be released from the cartridge into the interior of the container. Simultaneously, the downward force of the closure cap affects a sealing relationship between the undersurface of the flange of the cartridge and the upper land surface of the neck of the container.

The resulting mixture of the constituents, the concentrated material in the cartridge and the dilutant in the container, is dispensed from the container through a dip tube and a dispensing orifice as a spray or a stream of liquid in response to activation of a hand-pump associated with the closure cap.

U.S. Pat. No. 5,065,908 to Mengeu, U.S. Pat. No. 4,982,769 to Fournier et al., and U.S. Pat. No. 4,079,851 to Valyi disclose containers having an inward turned shoulder in a container neck. The '908 patent discloses a container of the foregoing type wherein a fitment seats on a shoulder in a container neck. The fitment is provided for controlling the flow rate of a powder or a liquid.

The '769 patent discloses a container to provide packaging for a vial device, wherein a flange formed on a lid engages a shoulder in a container neck. Although the flange is not required, it is an alternative adjunctive means of affecting a seal between the lid and the container.

The '851 patent discloses a composite container including an inner layer and an outer layer. A flange formed on the inner layer is united with a shoulder formed in the outer layer to prevent air from entering between the layers.

It has been found desirable to produce a concentrate containing cartridge and an associated dilutant containing container wherein a substantially fluid-tight seal can be readily achieved with a large variety of dispensing devices.

### SUMMARY OF THE INVENTION

It has surprisingly been discovered that by forming a recess in the uppermost land surface of the neck finish of a container to receive the annular outwardly extending flange of a concentrate containing cartridge, the above objectives, as well as others, may be achieved.

In one embodiment, the container comprising a neck finish having an open end and a recess formed therein, the recess adapted to receive a cartridge; and a main body having a hollow interior in communication with said neck finish.

In another embodiment, the container system comprising a main body having a hollow interior, a first closed end, and a spaced apart second end, the second end including a neck finish having an open end and external threads formed thereon, the open end including a recess formed therein; and a cartridge adapted to be disposed in the recess of the neck finish of said main body, said cartridge having a first open end forming a closure seat and a second end including a radially outwardly extending flange.

In another embodiment, the dispensing system comprising a main body having a hollow interior, a first closed end, and a spaced apart second end, the second end including a neck finish having an open end and external threads formed thereon, the open end including a recess formed therein; a cartridge adapted to be disposed in the recess of the neck finish of said main body, said cartridge having a first open end forming a closure seat and a second end including a radially outwardly extending flange; and a dispensing device including a dispenser and a closure cap, wherein the closure cap includes internal threads formed therein adapted to engage the external threads formed on the neck finish of said main body, and wherein the recess affects a sealing of the closure cap to said main body.

A container for dispensing a plurality of constituents is particularly useful where one of the constituents is introduced into the container from a cartridge holding a quantity of a concentrated material.

### BRIEF DESCRIPTION OF THE DRAWINGS

The above and other objects and advantages of the invention will become readily apparent to those skilled in the art from reading the following detailed description of the invention when considered in the light of the accompanying drawings, in which:

FIG. 1 is a fragmentary sectional view of a neck finish of a container in accordance with an embodiment of the present invention;

FIG. 2 is an elevational view partially in section of the container illustrated in FIG. 1 and a cartridge in accordance with an embodiment of the invention;

FIG. 3 is an elevational view partially in section of the container and cartridge illustrated in FIGS. 1 and 2 with the cartridge inserted into the container;

FIG. 4 is an exploded elevational view partially in section of the cartridge and the container illustrated in FIGS. 1-3 and an associated dispensing device;

FIG. 5 is an elevational view partially in section of the cartridge and the container illustrated in FIGS. 1-4, wherein the dispensing device is partially tightened on the neck finish of the container; and

FIG. 6 is an elevational view partially in section of the cartridge and the container illustrated in FIGS. 1-4, wherein the dispensing device is tightened on the neck finish of the container.

### DETAILED DESCRIPTION OF THE PREFERRED EMBODIMENTS OF THE INVENTION

The following detailed description and appended drawings describe and illustrate various exemplary embodiments of the present invention. The description and drawings serve to enable one skilled in the art to make and use the invention, and are not intended to limit the scope of the invention in any manner. It is understood that materials other than those described can be used without departing from the scope and spirit of the invention.

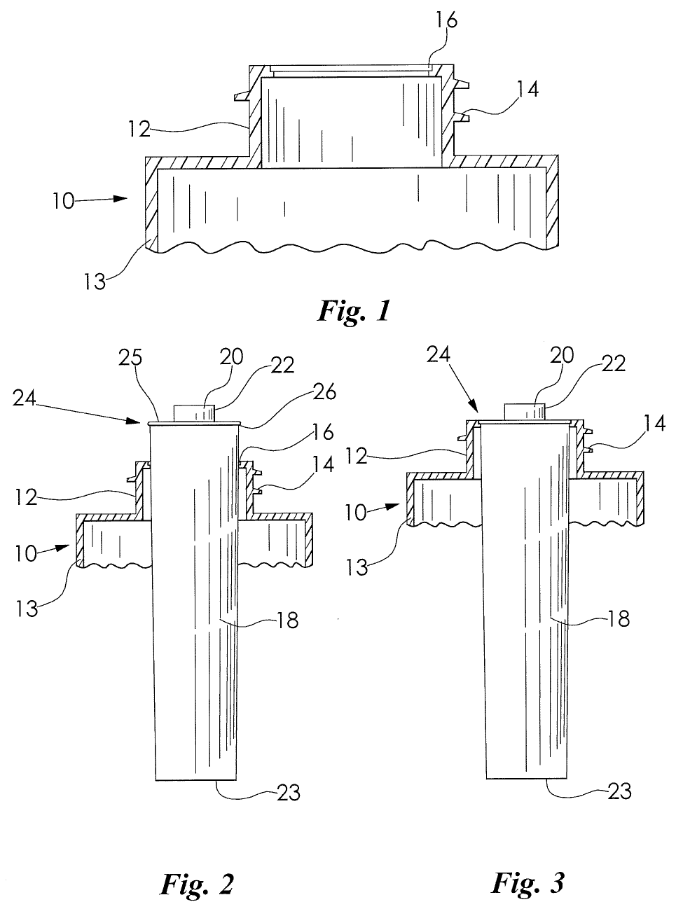

Referring now to FIG. 1, a container 10 according to an embodiment of the invention is shown. The container 10 includes a closed base (not shown), a neck finish 12, and a main body 13 for containing a diluent fluid such as water, for example. The container 10 may be produced from any conventional material as is known in the art, such as high-density polyethylene, for example.

The neck finish 12 is provided with external threads 14 formed on an outer surface thereof and an annular recess 16 formed at a distal end thereof. In the embodiment shown, the neck finish 12 has a substantially circular cross-section. However, it is understood that the neck finish can have any shape as desired.

FIG. 2 shows a concentrate cartridge 18 in accordance with an embodiment of the invention. The cartridge 18 may be of the type specifically illustrated and described in U.S. Pat. No. 6,290,100 as described above. Although a substantially circular cross-sectional shape is shown, other cross-sectional shapes can be used for the cartridge 18, such as a rectangular cross sectional shape, for example. The cartridge 18, includes an outer diameter slightly smaller than the inside diameter of the neck finish 12 and a hollow tube 20. The hollow tube 20 includes an open upper end 22 and a lower end 23 having a radially outwardly extending closure 27, as shown in FIG. 6. The cartridge 18 may be produced from any conventional material as is known in the art, such as high-density polyethylene, for example.

The cartridge 18 is provided with an outwardly extending annular flange 24 having an outer circumferential wall. The thickness of the wall of the flange 24 is determined by the spacing between an upper surface 25 and a lower surface 26 of the flange 24. When disposed in the recess 16 of the container 10, the upper surface 25 of the flange 24 is substantially flush with the upper land portion of the neck finish 12 as more clearly shown in FIG. 3.

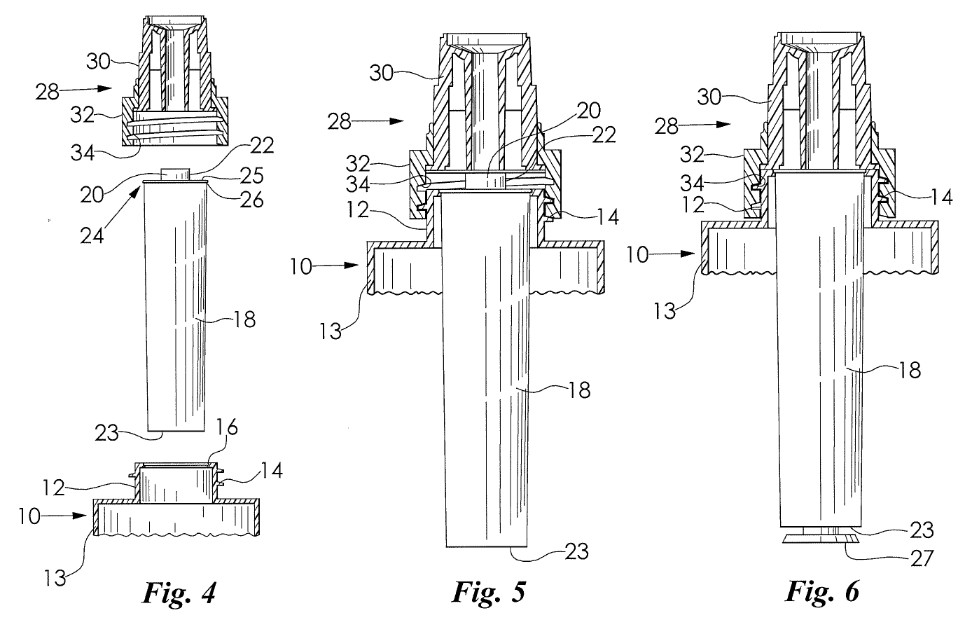

As illustrated in FIGS. 4 thru 6 the neck finish 12 of the container 10 communicates with the cartridge 18 and a dispensing device 28. The dispensing device 28 includes a dispenser 30 and a closure cap 32. The dispenser 30 shown is a pump-type sprayer. It is understood that other types of sprayers can be used as desired. The closure cap 32 includes internal threads 34 formed therein for engaging the external threads 14 formed on the neck finish 12. It is understood that other means of engagement may be used as desired such as a press fit, for example. When engaged with the container 10, the closure cap 32 is adapted to form a substantially fluid tight seal at the open end of the neck finish 12 of the container 10, as shown in FIGS. 5 and 6.

In operation, the lower end 23 of the cartridge 18 is inserted into the neck finish 12 of the container 10. The cartridge 18 is guided to seat properly within the neck finish 12 suspending the cartridge 18 within the container 10. The neck finish 12 of the container 10 is inserted into the closure cap 32 of the dispensing device 28. The internal threads 34 of the closure cap 32 are mated with the external threads 14 of the neck finish 12. The closure cap 32 is rotated, to affix the dispensing device 28 to the container 10. As the closure cap 32 is rotated, a sealing engagement occurs between the flange 24 and the recess 16. Simultaneously, the hollow tube 20 is urged downwardly to effectively move the closure 27 attached to the lower end 23 of the hollow tube 20 to an open position, as shown in FIG. 6, and thus allowing a concentrated material (not shown) contained in the cartridge 18 to flow from the cartridge 18 into the container 10.

It is appreciated that by forming the flange 24 receiving recess 16, a sealing effect can be achieved with a number of different styles of dispensing devices 28.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. A container comprising:
a neck finish having an open end and a recess formed therein, the recess adapted to receive a cartridge; and
a main body having a hollow interior in communication with said neck finish.

2. The container according to claim 1, wherein said neck finish is produced from high-density polyethylene.

3. The container according to claim 1, wherein said main body is produced from high-density polyethylene.

4. The container according to claim 1, wherein said neck finish includes external threads formed thereon adapted to engage internal threads of a closure cap.

5. The container according to claim 4, wherein the recess affects a sealing between the closure cap and said main body.

6. The container according to claim 1, wherein the recess formed in said neck finish is adapted to receive a flange of the cartridge.

7. The container according to claim 6, wherein the cartridge contains a concentrated material.

8. The container according to claim 1, wherein said main body includes a closed base portion.

9. The container according to claim 1, wherein said main body is adapted to contain a liquid diluent.

10. A container system comprising:
a main body having a hollow interior, a first closed end, and a spaced apart second end, the second end including a neck finish having an open end and external threads formed thereon, the open end including a recess formed therein; and
a cartridge adapted to be disposed in the recess of the neck finish of said main body, said cartridge having a first open end forming a closure seat and a second end including a radially outwardly extending flange.

11. The container system according to claim 10, wherein said main body is formed of high-density polyethylene.

12. The container system according to claim 10, further comprising a dispensing device disposed on said main body.

13. The container system according to claim 12, wherein the dispensing device is a pump-type sprayer.

14. The container system according to claim 10, wherein the recess formed in the neck finish is adapted to receive the flange of said cartridge.

15. The container system according to claim 14, wherein said cartridge is adapted to contain a concentrated material and said main body is adapted to contain a liquid diluent.

16. A dispensing system comprising:
a main body having a hollow interior, a first closed end, and a spaced apart second end, the second end including a neck finish having an open end and external threads formed thereon, the open end including a recess formed therein;
a cartridge adapted to be disposed in the recess of the neck finish of said main body, said cartridge having a first open end forming a closure seat and a second end including a radially outwardly extending flange; and
a dispensing device including a dispenser and a closure cap, wherein the closure cap includes internal threads formed therein adapted to engage the external threads formed on the neck finish of said main body, and wherein the recess affects a sealing of the closure cap to said main body.

17. The dispensing system according to claim 16, wherein said main body is formed of high-density polyethylene.

18. The dispensing system according to claim 16, wherein the recess formed in the neck finish is adapted to receive the flange of said cartridge.

19. The dispensing system according to claim 16, wherein said cartridge is adapted to contain a concentrated material and said main body is adapted to contain a liquid diluent.

20. The dispensing system according to claim 16, wherein the dispenser is a pump-type sprayer.
